(19) United States
(12) Patent Application Publication
(10) Pub. No.: US 2024/0412268 A1
(43) Pub. Date: Dec. 12, 2024

(54) SYSTEM AND METHOD FOR DIRECTING A POTENTIAL CUSTOMER TO A DIGITAL DESTINATION

(71) Applicant: FUJIFILM North America Corporation, Valhalla, NY (US)

(72) Inventor: Devin Perpetua, Warwick, NY (US)

(73) Assignee: FUJIFILM North America Corporation, Valhalla, NY (US)

(21) Appl. No.: 18/741,389

(22) Filed: Jun. 12, 2024

Related U.S. Application Data
(60) Provisional application No. 63/507,601, filed on Jun. 12, 2023.

(51) Int. Cl. G06Q 30/0601; G06K 19/07

(52) U.S. Cl. CPC G06Q 30/0625; G06K 19/0723; G06Q 30/0621

(57) ABSTRACT

A system and method for directing a potential customer to a URL, the system including a paper-based print product associated with an unprogrammed or reprogrammable Near Field Communication (NFC) chip, and an application with an ability to program the NFC chip with a URL is provided. The method includes providing to a user a paper-based print product associated with an unprogrammed or reprogrammable an NFC chip, programming the NFC chip with a URL, resulting in a programmed paper-based print product, accessing by the potential customer the programmed paper-based print product to receive or obtain the URL, communicating by the potential customer via NFC with the programmed paper-based print product, and automatically directing the potential customer to the URL based on the communicating.

### CROSS-REFERENCE TO RELATED APPLICATIONS

This application claims the benefit of U.S. Patent Application No. 63/507,601 filed on Jun. 12, 2023, the contents of which are hereby incorporated by reference in their entirety.

### TECHNICAL FIELD

The present invention relates to the field of paper-based print product; and more particularly relates to a system and method for directing customers to a paper-based print product related website or product builder on a web site or mobile application.

### BACKGROUND OF THE INVENTION

Being able to link users to additional digital content when viewing, for example, a physical printed photo, photobook or photo greeting card has historically been a challenge. Current methods involve a QR code that is disruptive to the photo, or using image recognition software. Within photo printing, a significant challenge is directing customers to a product builder on a web site or mobile application. With physical product displays within a retail environment, once a customer sees a print product (e.g., a photo mug), the retailer still needs to show the customer how to navigate to a website or photo product builder to place their order.

Accordingly, there exists a need for improved systems and methods for directing customers to a product related website or product builder on a web site or mobile application. The present invention addresses the above-noted needs as well as other needs.

### SUMMARY OF THE INVENTION

It is, therefore, an aspect of the present invention to provide a system and method for directing customers to a product related website or product builder on a web site or mobile application. The problems noted above with existing solutions can be overcome by including a Near Field Communication (NFC) chip into or on the paper-based print product, which allows a user to use, for example, a mobile computing unit, for example, a cell or “smart” phone with built in NFC chip to, at a minimum, scan the paper-based print product and get further information, for example, a destination on a network or a link to digital content. Leveraging NFC chips applied onto or within paper-based signage would allow physical product displays to then automatically direct the customer to the specific product on display.

In a first aspect, the invention provides a system for directing a potential customer to a Uniform Resource Locator (URL), the system comprising: a paper-based print product associated with an unprogrammed or reprogrammable Near Field Communication (NFC) chip; and an application with an ability to program the NFC chip with a URL.

In a second aspect, the invention provides a method of directing a potential customer to a Uniform Resource Locator (URL), the method comprising: providing to a user a paper-based print product associated with an unprogrammed or reprogrammable Near Field Communication (NFC) chip; programming the NFC chip with a URL, resulting in a programmed paper-based print product; accessing by the potential customer the programmed paper-based print product to receive or obtain the URL; communicating by the potential customer via NFC with the programmed paper-based print product; and automatically directing the potential customer to the URL based on the communicating.

Additional objects, advantages and novel aspects of the present invention will be set forth in part in the description which follows, and will in part become apparent to those in the practice of the invention, when considered with the attached figures.

### BRIEF DESCRIPTION OF THE DRAWINGS

The above-mentioned and other features and advantages of this invention, and the manner of attaining them, will become apparent and be better understood by reference to the following description of the invention in conjunctions with the accompanying drawings, wherein:

FIG. 1 is a block diagram depicting one example of a system for directing a potential customer to a URL, in accordance with one or more aspects of the present invention;

FIG. 2 is a block diagram depicting one example the NFC chip embedded in the paper-based print product of FIG. 1, in accordance with one or more aspects of the present invention;

FIG. 3 is a flow diagram for one example of a method of directing a potential customer to a URL, in accordance with one or more aspects of the present invention;

FIG. 4 is a flow diagram for another example of a method of directing a potential customer to a URL, in accordance with one or more aspects of the present invention; and

FIG. 5 is a block diagram of one example of a computing environment in which the present invention may be practiced, in accordance with one or more aspects of the present invention.

### DETAILED DESCRIPTION OF THE INVENTION

As used herein, the term “paper-based print product” refers to various forms of paper (non-limiting examples include photo paper, printing paper, stock paper of various thicknesses, cardboard, etc.) that include or are configured for print of some type thereon, for example, one or more images and/or one or more alphanumeric characters. Non-limiting examples include a previously printed photo or photo paper configured for printing one or more images thereon, signage with, for example, one or more alphanumeric characters and/or one or more images thereon, or blank signage configured for printing thereon, physical product displays including paper of some type that either is blank or has one or more alphanumeric characters and/or one or more images, and pre-folded paper of various thicknesses for various purposes, such as, for example, a blank or printed greeting card, a photo greeting card (printed or configured for printing) or a photobook.

As used herein, the term “NFC chip” refers to a chip (e.g., semiconductor chip) enabling an electronic device (e.g., a mobile computing unit) to communicate with another NFC-enabled electronic device (e.g., unidirectional or bidirectional communication). An “NFC chip” may also include an NFC tag (powered or powerable via NFC) over distances of less than about 20 cm or less (e.g., about 4 cm to about 10 cm).

As used herein, the term “mobile computing unit” refers to any device with one or more processors, memory (e.g., short-term memory (e.g., Read Only Memory or RAM) and long-term memory (e.g., solid-state memory)) and the ability to communicate wirelessly via NFC and/or NFC and another type of communication (e.g., another short range communications protocol) with a faster, longer range than NFC (e.g., Bluetooth, Wi-Fi, etc.) on which the NFC signal can be carried further.

As used herein, the term “URL” refers to a digital destination on a network, such as a local area network, wide-area network or global communications network, such as the Internet that is programmed into an NFC chip associated with or embedded within or on a paper-based print product. The destination can take any form that directs a user using a mobile or other computing unit to a destination on the network, for example, a Uniform Resource Locator, IP address or other digital destination form.

Near-field communication (NFC) is a set of communication protocols that enables communication between two electronic devices over a short distance, for example, about 4 cm to about 10 cm and potentially more. NFC offers a low-speed connection through a simple setup that can be used to bootstrap another type of wireless connection that has characteristics better suited to the application (e.g., speed and/or distance). Like other “proximity card” technologies, NFC is based on inductive coupling between two “antennas” present on NFC-enabled devices, for example, a smartphone and a printer, communicating in one or both directions, using a frequency of, for example, 13.56 MHz in the globally available unlicensed radio frequency ISM band using, for example, the ISO/IEC 18000-3 air interface standard at data rates ranging from about 106 to about 424 kbit/s and possibly more. Secure communications are available by applying, for example, encryption algorithms as is done for credit cards.

NFC standards cover communications protocols and data exchange formats that are based on existing radio-frequency identification (RFID) standards. NFC-enabled portable or stationary devices can be provided with application software (e.g., mobile application software), for example, to read electronic tags or make payments when connected to an NFC-capable system. These are standardized to NFC protocols, replacing proprietary technologies used by earlier systems.

NFC-based communications involve an initiator and a target; the initiator actively generates a radio frequency (RF) field that can, for example, power a passive target. This enables NFC targets to take very simple form factors such as unpowered tags, stickers, key fobs, or cards. NFC peer-to-peer communication is possible, provided both devices are powered.

NFC tags contain data and may be read-only, but may be writable. The tags can securely store (using encryption) personal data such as debit and credit card information, loyalty program data, PINs and networking contacts, among other information. There are several types of tags available that provide different communication speeds and capabilities in terms of configurability, memory, security, data retention and write endurance.

As with proximity card technology, NFC uses inductive coupling between two nearby loop antennas effectively forming an air-core transformer. Because the distances involved are very small compared to the wavelength of electromagnetic radiation (radio waves) of the frequency used, the interaction is described as “near field.” An alternating magnetic field is the main coupling factor and very little power is radiated in the form of radio waves, which minimizes interference between such devices and any radio communications at the same frequency or with other NFC-enabled devices much beyond their intended range. NFC currently operates within the globally available and unlicensed radio frequency ISM band of, for example, 13.56 MHZ. Most of the RF energy is concentrated, for example, in the ±7 kHz bandwidth allocated for that band, but the emission's spectral width can be as wide as 1.8 MHz in order to support high data rates.

Working distance with compact standard antennas and realistic power levels could theoretically be up to about 20 cm, however, in practice the working distances do not exceed 10 cm. The communication takes place between an active “initiator” device and a target device which may either be passive or active. Where passive, the initiator device provides a carrier field and the target device, acting as a transponder, communicates by modulating the incident field. In this mode, the target device may draw its operating power from the initiator-provided magnetic field. Where active, both the initiator and the target device communicate by alternately generating their own fields. A device in the active scenario stops transmitting in order to receive data from the other. This mode requires that both devices include some type of power supply. As used herein, “associated” means the NFC chip is intended to be physically close to or embedded within or on the paper-based print product. For example, the NFC chip may be woven or sandwiched into the paper-based print product.

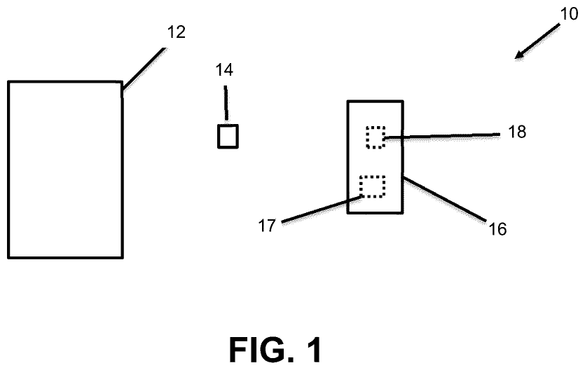

Turning to the figures, FIG. 1 is a block diagram depicting one example of a system 10 for directing a potential customer to a URL, in accordance with one or more aspects of the present invention. The system 10 includes, for example, a paper-based print product 12, with or without one or more alphanumeric characters and/or one or more images printed thereon. Paper-based print product 12 is associated with an NFC chip 14. For example, NFC chip 14 may be physically close to the paper-based print product 12 when NFC chip 14 is affixed to packaging, shelving, or a display surrounding or holding paper-based print product 12. System 10 also includes, for example, a mobile computing unit 16 storing therein an application 18 for “writing” information, such as a destination, for example, a URL, IP address or other destination information, on a network (local area, wide area or a global computer network such as the Internet) to NFC chip 14, encrypted or unencrypted, on the NFC chip 14. Preferably, encryption is used for sensitive information, such as, for example, personally identifiable information, passwords, access codes, financial information, etc. Mobile computing unit 16 is NFC-communication enabled via an integrated NFC chip 17.

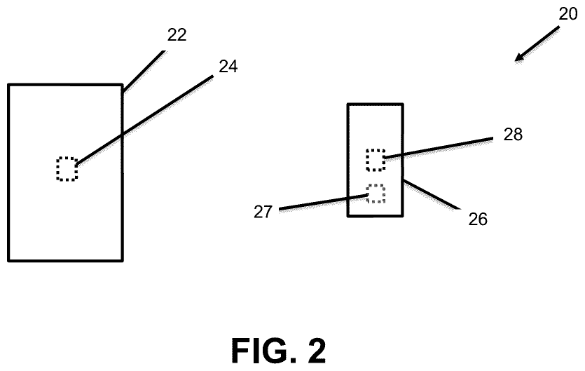

FIG. 2 is a block diagram depicting another example of a system 20 for directing a potential customer to a destination on a network, such as a URL. System 20 includes, for example, paper-based print product 22, embedded NFC chip 24, mobile computing unit 26, NFC writing application 28 and integrated mobile NFC chip 27. System 20 is similar to system 10 of FIG. 1, except that the NFC chip 24 is embedded within or on paper-based print product 22 (as show in FIG. 2, it is embedded). The embedding can be accomplished in a number of ways, for example, weaving it into paper-based print product 22, similar to a security strip embedded in legal tender, sandwiching it between two or more layers of paper-based print product 22, or be affixed to a surface of paper-based print product 22, for example, in the form of a sticker or other substrate with a similarly thin body, attached, for example, by adhesive.

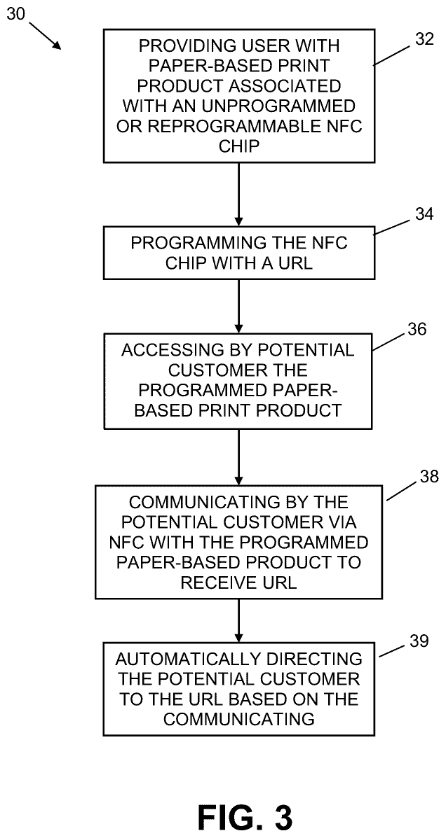

FIG. 3 is a flow diagram for one example of a method 30 of directing a potential customer to a URL, in accordance with one or more aspects of the present invention. Method 30 may include, for example, providing the user with a paper-based print product with an associated unprogrammed or reprogrammable NFC chip at operation 32. Method 30 may further include, for example, programming the NFC chip associated with the paper-based print product with a URL at operation 34, which may or may not include using some form of encryption. Method 30 may also include, for example, accessing by the potential customer the programmed paper-based print product at operation 36. Method 30 may further include, for example, communicating by the potential customer via NFC with the programmed paper-based print product in order to receive or obtain the URL at operation 38. Method 30 may also include, for example, automatically directing the potential customer to the URL based on the communicating at operation 39.

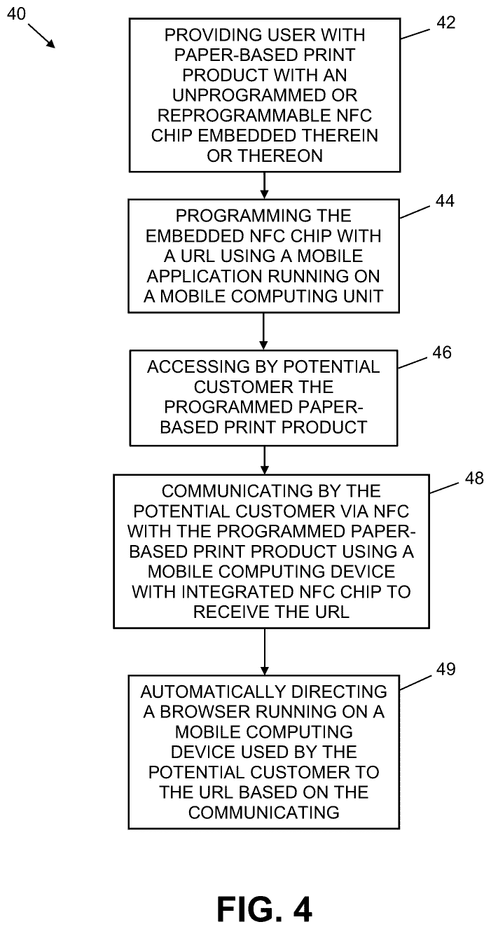

FIG. 4 is a flow diagram for another example of a method 40 of directing a potential customer to a URL, in accordance with one or more aspects of the present invention. Method 40 may include, for example, providing a user with a paper-based print product with an unprogrammed or reprogrammable NFC chip embedded within or on the paper-based print product at operation 42. Method 40 may also include, for example, programming the embedded NFC chip with a URL using a mobile application running on a mobile computing unit at operation 44. Method 40 may further include, for example, accessing by the potential customer the programmed paper-based print product at operation 46. Method 40 may additionally include, for example, communicating by the potential customer via NFC with the programmed paper-based print product using a mobile computing unit with an integrated NFC chip to receive or otherwise obtain the URL at operation 48. Method 40 may also include, for example, automatically directing a browser running on the mobile computing unit used by the potential customer to the URL based on the communicating at operation 49.

The methods of FIGS. 3 and 4 (and variations thereof covered hereby) may be stored on a non-transitory computer-readable medium.

In one scenario, the paper-based print product may take the form of photo paper with an NFC chip therein or thereon (e.g., multiples thereof) and, in one example, an image printed thereon that, in one example, has been delivered to a customer by a photo printing service or picked up by the user. In either case, the customer opens the application (e.g., a mobile application running on a mobile computing unit) associated with the photo printing service used by the customer to order the photo. The mobile application includes an NFC writer feature and the mobile computing unit has an NFC chip integrated therewith. The customer may then enter a URL to where they would like to direct someone and the application “writes” the URL, with or without encryption, to the NFC chip embedded within or on the paper-based print product. The customer may then send or provide to one or more recipients having the ability to read from the programmed NFC chip within or on the paper-based print product, which the recipient(s) may then be automatically directed to the URL.

In another scenario, the paper-based print product takes the form of signage or a physical product display (e.g., in a retail or other “brick and mortar” location) with an NFC chip embedded therein or thereon. The NFC chip is programmed with the URL of a digital destination the product builder (e.g., the manufacturer or distributor providing the product on display) desires to direct a potential customer. A customer or visitor at the location may then read with their mobile computing unit via NFC the URL from the signage or physical product display, which automatically directs the mobile computing unit to the programmed URL, which may be a landing page of a product associated with the signage or physical print product.

Although a mobile computing unit is used as an example herein, it should be understood that a stationary computing device (e.g., a desktop computer or server) with an NFC chip or the ability to communicate, wired or wirelessly, to a stationary or portable device with an NFC chip, for example, a handheld device similar to a bar code reader but with the ability to write to another NFC chip or bidirectional NFC communication. Such a device could be a mobile computing unit or a special purpose electronic device relying on the stationary computing device.

In a first aspect, the present invention includes, for example, a system for directing a potential customer to a URL. The system includes, for example, a paper-based print product associated with an unprogrammed or reprogrammable Near Field Communication (NFC) chip and an application running on a computing unit (e.g., a mobile computing unit) with an ability to program the NFC chip with a URL.

In one example, the paper-based print product of the system of the first aspect may include photo paper. In another example, the paper-based print product of the system of the first aspect may include signage. In still another example, the paper-based print product of the system of the first aspect may include a physical product display. In yet another example, the paper-based print product of the system of the first aspect may include a photo greeting card.

In a first example, the application of the system of the first aspect may include a mobile application running on a mobile computing unit with an NFC chip for communicating with the associated NFC chip. In a second example, the associated NFC chip of the system of the first aspect may be embedded within or on the paper-based print product.

In a second aspect, the present invention includes a method of directing a potential customer to a URL. The method may include, for example, providing to a user a paper-based print product associated with an unprogrammed or reprogrammable Near Field Communication (NFC) chip. The method may also include, for example, programming the NFC chip with a URL, resulting in a programmed paper-based print product. The method may further include, for example, accessing by the potential customer the programmed paper-based print product to receive the URL. The method may also include, for example, communicating by the potential customer via NFC with the programmed paper-based print product. The method may additionally include, for example, automatically directing the potential customer to the URL based on the communicating.

In an example, the programming of the method of the second aspect may include, for example, using a mobile application running on a mobile computing unit and, for example, the programming may be performed by the user. As another example, the programming may include the programming being performed for the user.

In one example, the communicating of the method of the second aspect may be performed using a mobile computing unit with NFC chip.

In an example, the automatically directing of the method of the second aspect may include automatically directing a browser running on a mobile computing unit used by the potential customer to the URL based on the communicating.

In a first example, the paper-based print product associated with the unprogrammed or reprogrammable NFC chip of the method of the second aspect may include photo paper. In a second example, the paper-based print product associated with the unprogrammed or reprogrammable NFC chip of the method of the second aspect may include signage. In a third example, the paper-based print product associated with the unprogrammed or reprogrammable NFC chip of the method of the second aspect may include a physical product display. In a fourth example, the paper-based print product associated with the unprogrammed or reprogrammable NFC chip of the method of the second aspect may include a photo greeting card.

In one example, the associated unprogrammed or reprogrammable NFC chip of the method of the second aspect may be embedded within or on the paper-based print product.

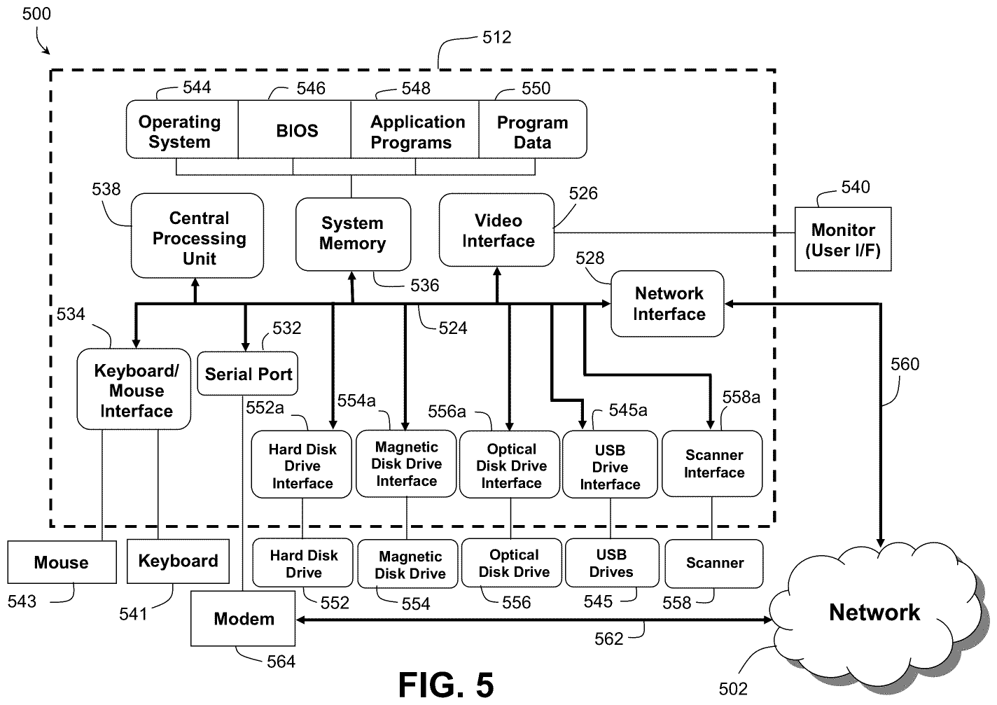

FIG. 5 shows the components of an exemplary computing environment 500 that may be used to implement any of the methods and processing thus far described. The following description of computers also applies to the various user computing units, which may be, for example, mobile computing units and, where present, a server for implementing the system and methods described above with reference to FIGS. 1-4. Computing environment 500 may include one or more computers 512 comprising a system bus 524 that couples a video interface 526, network interface 528, a keyboard/mouse or touch-based interface 534, and a system memory 536 to a Central Processing Unit (CPU) 538. A monitor, display (or mobile computing unit screen or display) 540 is connected to bus 524 by video interface 526 and provides the user with a graphical user interface to program the URL as described above. The graphical user interface allows the user to enter commands and information into computer 512 using an interface control that may include a keyboard 541 and may also include a user interface selection device 543 (e.g., a mouse, touch screen, or other pointing device). Keyboard 541 and user interface selection device are connected to bus 524 through keyboard/mouse interface 534. The display 540 and user interface selection device 543 may be used in combination to form the graphical user interface which allows the user to implement at least a portion of the present invention. Other peripheral devices may be connected to the remote computer through universal serial bus (USB) drives 545 to transfer information to and from computer 512. For example, cameras and camcorders may be connected to or integrated with computer 512 through serial port 532 or USB drives 545 so that data representative of a digitally represented still image, video, audio or other digital content may be downloaded to memory 536 or another memory storage device associated with computer 512.

The system memory 536 is also connected to bus 524 and may include read only memory (ROM), random access memory (RAM), an operating system 544, a basic input/output system (BIOS) 546, application programs 548 and program data 550. The computer 512 may further include a hard disk drive 552 for reading from and writing to a solid state storage device, a hard disk, a magnetic disk drive 554 for reading from and writing to a removable magnetic disk (e.g., floppy disk), and an optical disk drive 556 for reading from and writing to a removable optical disk (e.g., CD ROM or other optical media). The computer 512 may also include USB drives 545 and other types of drives for reading from and writing to flash memory devices (e.g., compact flash, memory stick/PRO and DUO, SD card, multimedia card, smart media xD card), and may include a scanner/NFC chip 558 for, respectively, scanning items such as still image photographs to be downloaded to computer 512 or an NFC chip with read or read and write capabilities. A hard disk drive interface 552a, magnetic disk drive interface 554a, an optical drive interface 556a, a USB drive interface 545a, and a scanner/NFC interface 558a operate to connect bus 524 to hard disk drive 552, magnetic disk drive 554, optical disk drive 556, USB drive 545 and scanner 558, respectively. Each of these drive components and their associated computer-readable media may provide computer 512 with non-volatile storage of computer-readable instruction, program modules, data structures, application programs, an operating system, and other data for computer 512. In addition, it will be understood that computer 512 may also utilize other types of computer-readable media in addition to those types set forth herein, such as digital video disks, random access memory, read only memory, other types of flash memory cards, magnetic cassettes, and the like.

Computer 512 may operate in a networked environment using logical connections with network 502. Network interface 528 provides a communication path 560 between bus 524 and network 502, which allows, for example, digital images 25 and other information to be communicated to a server or database for storage and allowing access to other users. The digital images 25 and other information may also be communicated from bus 524 through a communication path 562 to network 502 using serial port 532 and a modem 564. It will be appreciated that the network connections shown herein are merely examples, and it is within the scope of the present invention to use other types of network connections between computer 512 and network 502 including both wired and wireless connections.

Accordingly, embodiments of the present invention provide improved systems and methods for directing customers to a product related website or product builder on a web site or mobile application.

From the foregoing, it will be seen that this invention is one well adapted to attain all the ends and objects hereinabove set forth together with other advantages which are obvious and which are inherent to the method and apparatus. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirements.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A system for directing a potential customer to a URL, the system comprising:
a paper-based print product associated with an unprogrammed or reprogrammable Near Field Communication (NFC) chip; and
an application running on a computing unit with an ability to program the NFC chip with the URL.

2. The system of claim 1, wherein the paper-based print product comprises photo paper.

3. The system of claim 1, wherein the paper-based print product comprises signage.

4. The system of claim 1, wherein the paper-based print product comprises a physical product display.

5. The system of claim 1, wherein the paper-based print product comprises a greeting card.

6. The system of claim 1, wherein the application comprises a mobile application and the computing unit comprises a mobile computing unit with an NFC chip for communicating with the associated NFC chip.

7. The system of claim 1, wherein the associated NFC chip is embedded within or on the paper-based print product.

8. A method of directing a potential customer to a URL, the method comprising:
providing to a user a paper-based print product associated with an unprogrammed or reprogrammable Near Field Communication (NFC) chip;
programming the NFC chip with the URL, resulting in a programmed paper-based print product;
accessing by the potential customer the programmed paper-based print product;
communicating by the potential customer via NFC with the programmed paper-based print product to receive the URL; and
automatically directing the potential customer to the URL based on the communicating.

9. The method of claim 8, wherein the programming comprises using a mobile application running on a mobile computing unit.

10. The method of claim 9, wherein the programming is performed by the user.

11. The method of claim 9, wherein the programming is performed for the user.

12. The method of claim 8, wherein the communicating is performed using a mobile computing unit with NFC chip.

13. The method of claim 8, wherein the automatically directing comprises automatically directing a browser running on a mobile computing unit used by the potential customer to the URL based on the communicating.

14. The method of claim 8, wherein the paper-based print product associated with the unprogrammed or reprogrammable NFC chip comprises photo paper.

15. The method of claim 8, wherein the paper-based print product associated with the unprogrammed or reprogrammable NFC chip comprises signage.

16. The method of claim 8, wherein the paper-based print product associated with the unprogrammed or reprogrammable NFC chip comprises a physical product display.

17. The method of claim 8, wherein the paper-based print product associated with the unprogrammed or reprogrammable NFC chip comprises a greeting card.

18. The method of claim 8, wherein the associated unprogrammed or reprogrammable NFC chip is embedded within or on the paper-based print product.
